(19) United States
(12) Patent Application Publication
(10) Pub. No.: US 2017/0243243 A1
(43) Pub. Date: Aug. 24, 2017

(54) MONITORING AND POLICING ONLINE ADVERTISEMENTS

(71) Applicant: Ad Lightning, Inc., Seattle, WA (US)

(72) Inventors: Ryan Kosai, Seattle, WA (US); Michael Galgon, Seattle, WA (US)

(21) Appl. No.: 15/439,351

(22) Filed: Feb. 22, 2017

Related U.S. Application Data
(60) Provisional application No. 62/298,379, filed on Feb. 22, 2016.

(51) Int. Cl. G06Q 30/02; H04L 29/08

(52) U.S. Cl. CPC G06Q 30/0242; H04L 67/306; H04L 67/20; G06Q 30/0277

(57) ABSTRACT

Disclosed is a system and method for monitoring and policing online advertisements. A content provider website serves at least a first webpage having first-party content, and third-party content. Embodiments are disclosed that visit the content provider website and retrieve the webpage. Content of the website is evaluated and assigned a score. The content evaluated may be either the first-party content or the third-party content or both. If the score fails a predetermined criteria, a report is generated.

### RELATED PATENTS

This application claims priority to and the benefit of co-pending U.S. Provisional Patent No. 62/298,379, filed on Feb. 22, 2016, entitled “Monitoring and Policing Online Advertisements,” the disclosure of which is hereby incorporated by reference for all purposes as if set forth here in its entirety.

### TECHNICAL FIELD

The disclosed subject matter pertains generally to the area of online advertising, and more specifically to the area of monitoring and policing online advertisements.

### BACKGROUND INFORMATION

Online content providers often engage third-party advertising affiliates to present advertisements (“ads”) on the websites of the content providers. For example, the host of a successful website may receive a high number of page views per month, thereby creating a desirable platform for advertising. Online technology enables targeted ads based on a visitor's browsing history. However, successful content providers rarely desire to dedicate resources to the task of managing a targeted advertising platform. Accordingly, content providers typically engage advertising affiliates to acquire and curate the advertisements that are ultimately displayed on the content provider's website.

Problems sometimes arise with such systems because the affiliate may serve ads that are inconsistent with the content provider's image or desires. Similarly, poorly implemented ads may hamper the performance of the content provider's website. Affiliate ads may also create other problems. Currently, there is no efficient tool for policing online advertisements.

### SUMMARY OF EMBODIMENTS

Embodiments are directed to a tool for monitoring online advertisements and policing such advertisements based on a scoring system.

### BRIEF DESCRIPTION OF THE DRAWINGS

The following detailed description may be better understood with reference to the accompanying drawings, in which like numerals represent like elements throughout the several figures, which are briefly described as follows:

FIG. 1 is a functional block diagram generally illustrating a system for monitoring and policing online advertisements, in accordance with the disclosure.

FIGS. 2A and 2B are a functional block diagrams generally illustrating the creation of a dynamic webpage having external ads, in accordance with the disclosure.

FIG. 3 is a sequence diagram generally illustrating the flow of information between components in an online advertising environment, in accordance with this disclosure.

FIG. 4 is a functional block diagram generally illustrating the flow of data between components in an online advertising environment, in accordance with this disclosure.

FIG. 5 is a conceptual diagram generally illustrating the creation of a synthetic profile using an ad monitor, constructed in accordance with this disclosure.

FIG. 6 is a functional block diagram generally illustrating components of an ad monitor constructed in accordance with this disclosure.

FIG. 7 is a logical flow diagram generally illustrating a system for monitoring and policing online advertisements, in accordance with certain embodiments.

FIG. 8 is a functional block diagram generally illustrating one possible example of a computing device that may be used in various embodiments.

### DETAILED DESCRIPTION

Generally described, the disclosure is directed to a system for monitoring and policing online advertisements. Embodiments implement a tool for monitoring ads served on a website and scoring one or more of the ads. Based on the score of the ads, feedback is reported, such as to a proprietor of the website. In preferred embodiments, the feedback may be used to alter the ads served on the website, in character, in nature, in amount, or the like.

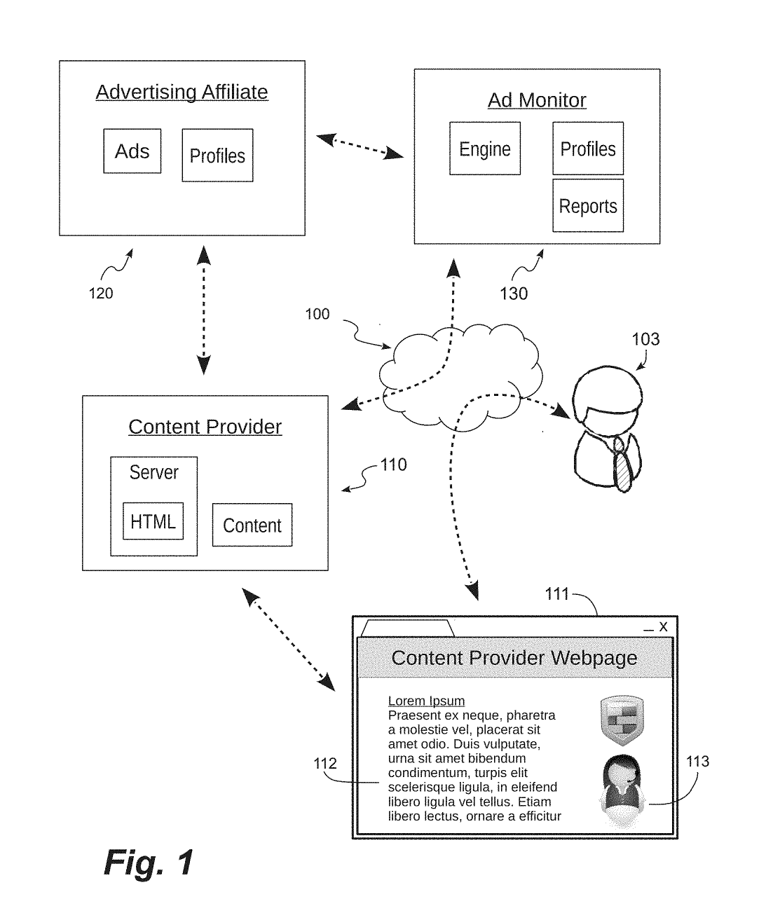

FIG. 1 is a functional block diagram generally illustrating a tool for monitoring and policing online advertisements. Illustrated are a content provider 110, an advertising affiliate 120, and an ad monitor 130. Generally stated, the content provider 110 includes a web server for serving content, typically in the form of static or dynamic webpages, constructed using languages such as HTML, PHP, Perl, CGI, ASP, or the like. The content provider 110 may serve up one or more webpages, such as webpage 111. In accordance with implementations of this disclosure, the webpage 111 includes code, such as markup language instructions, that defines both content 112 and ads 113. The content 112 is typically provided by the content provider 110. However, the ads 113 are generally provided by the advertising affiliate 120.

The advertising affiliate 120 is typically engaged by the content provider 110 to provide context-sensitive (targeted) ads to be displayed in conjunction with the content 112 on the content provider's web site 111. The advertising affiliate 120 typically selects the appropriate ad for display on the web site 111 from a data store of available ads. The advertising affiliate 120 commonly contracts with various advertisers who provide the ads to the advertising affiliate 120 together with information about the target audience for each ad. Generally, profiles are maintained that associate which type of visitor should receive which types of ads. In other words, a visitor having a particular profile may be more receptive to a particular type of ad, whereas a visitor with a different profile may be more receptive to a different type of ad. Advertising profiles are generally constructed by monitoring the online habits (e.g., browsing history, search history, purchase history, or the like).

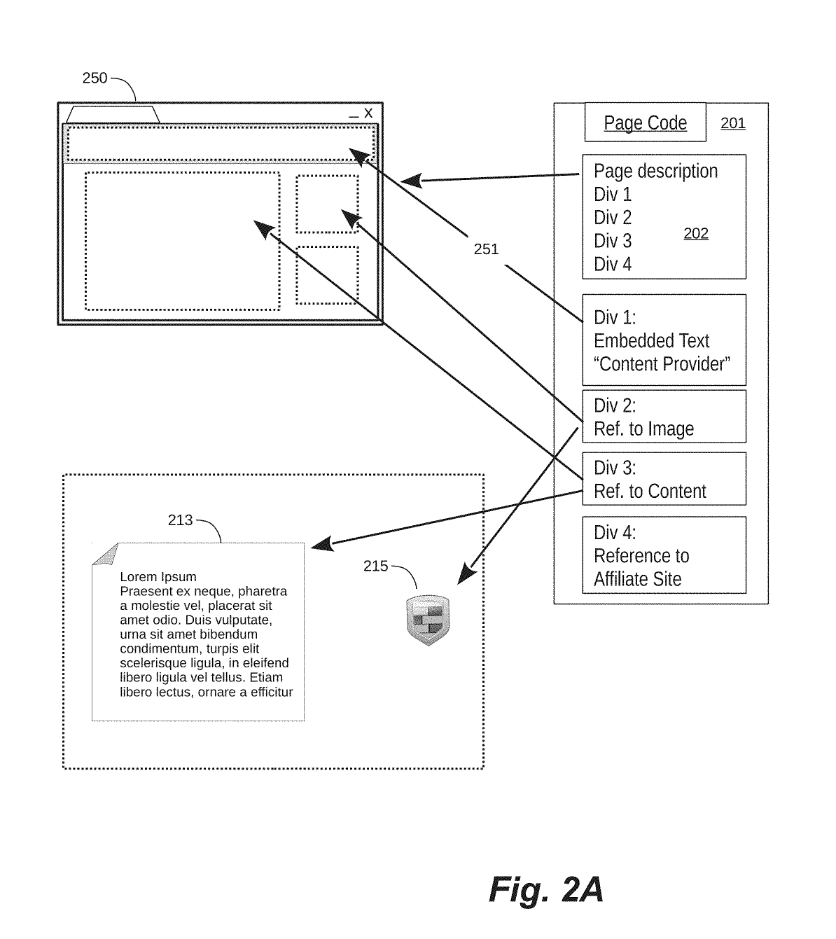

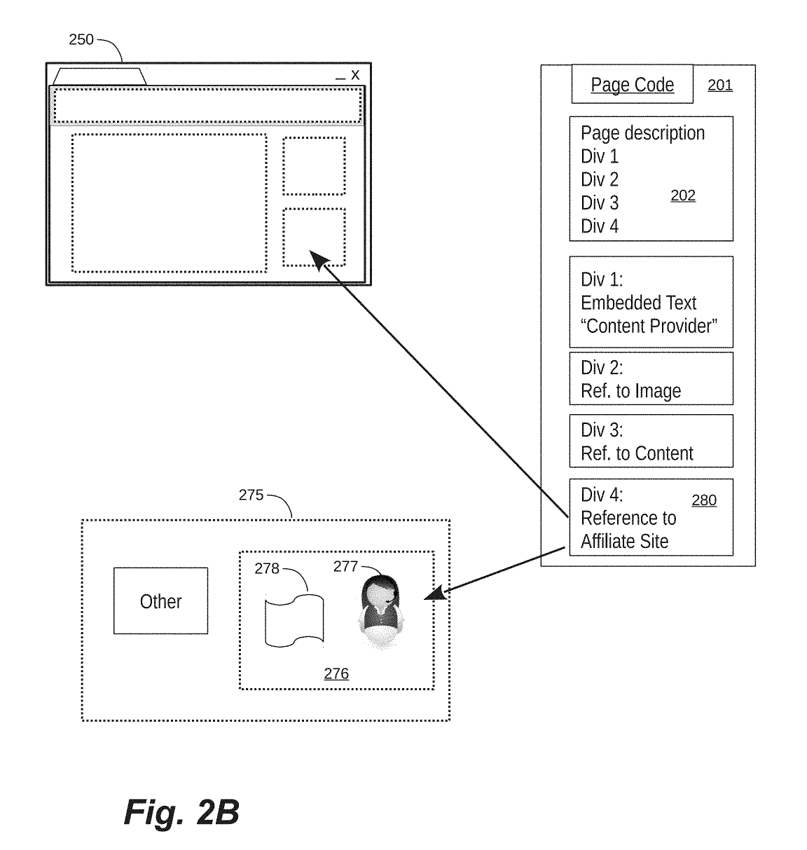

Accordingly, when a particular visitor lands at the web site 111, the content provider 110 serves up the webpage 111, but the advertising affiliate makes a determination about which ad (e.g., ad 113) to serve in conjunction with the content 112 from a profile built up of the visitor. Often, the profile is derived from, or influenced by, user-specific data stored on the visitor's computing system. One environment for serving ads based on a user's web browsing history is illustrated in FIGS. 2-4 and described in detail below. Briefly stated, when the visitor 103 lands on the web site 111, a profile is constructed or evaluated for the visitor 103. That profile is used by the advertising affiliate 120 to select an ad to be served to that visitor 103.

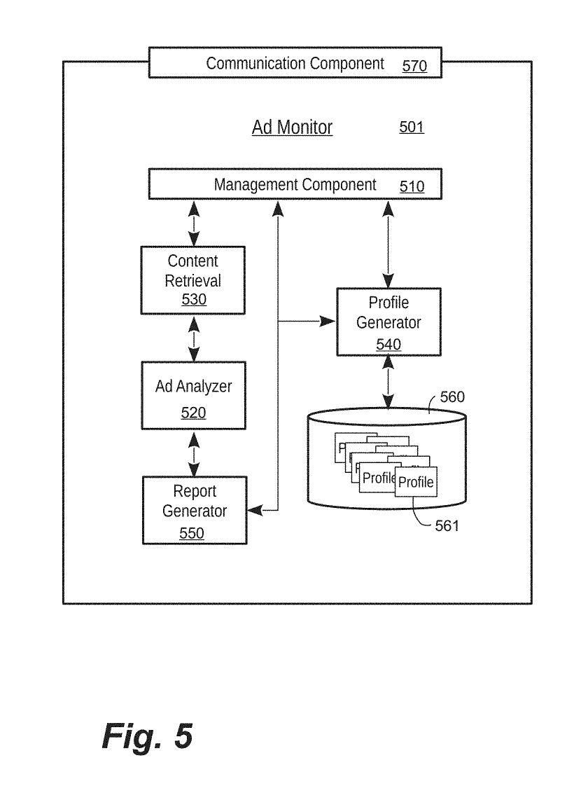

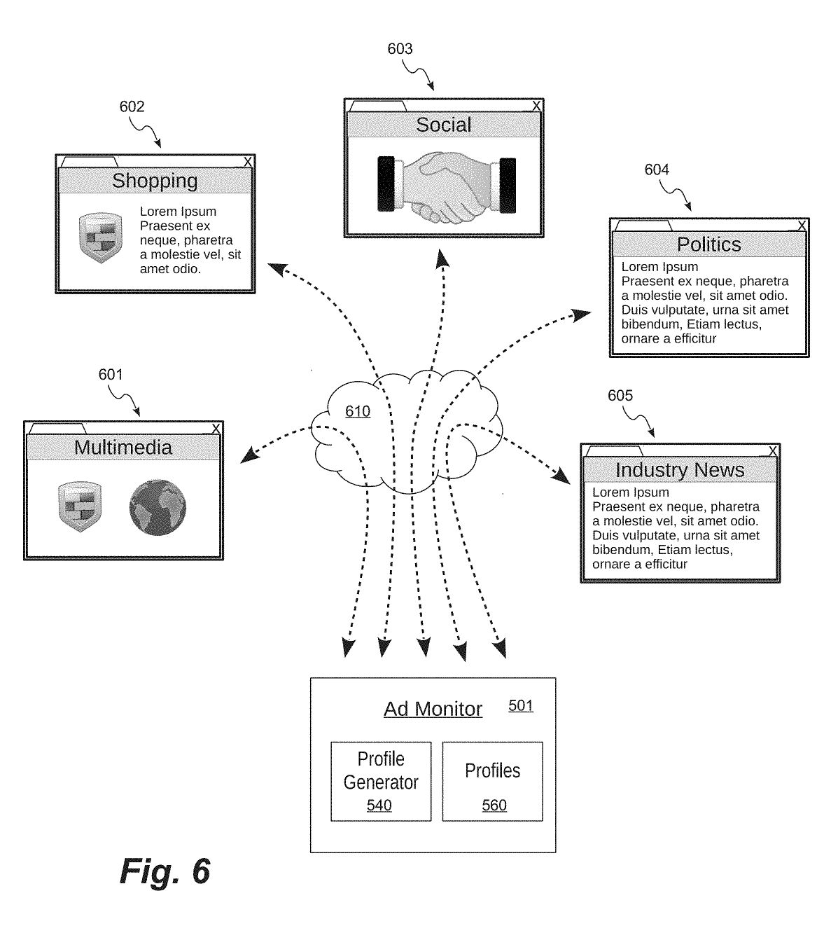

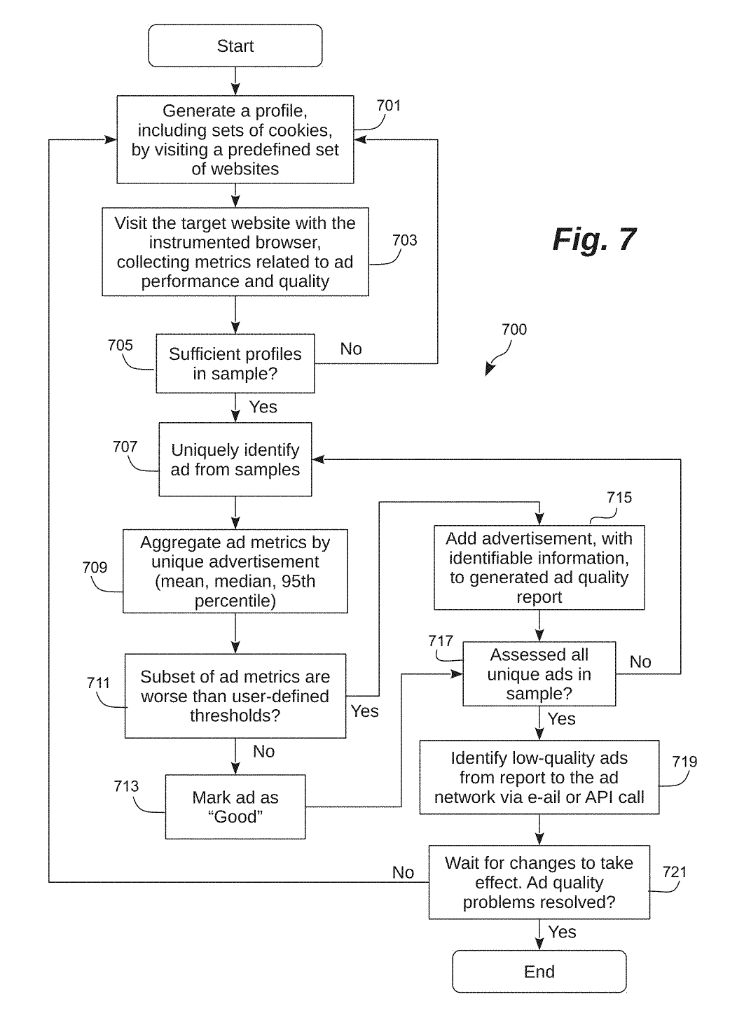

The ad monitor 130 is a tool that, with the cooperation of the content provider 110, evaluates the character of ads being served on the content provider's web site 111. One specific implementation of the ad monitor 130 is illustrated in FIGS. 5 and 6, and described below. Generally described, the ad monitor 130 includes an evaluation engine that manages a process for quantifying the performance and quality of online advertisements. Particular details of the process are illustrated in FIG. 7 and described below. Generally stated, the ad monitor 130 begins by building a pseudo-profile that simulates a member of the content provider's target audience, such as the visitor. The ad monitor 130 may build the pseudo-profile by visiting various sites that ordinary visitors of the content provider's website 111 would be expected to visit. Then, with the pseudo-profile built, the ad monitor 103 visits the webpage 111 and evaluates the ads that are served, such as ad 113. The ad monitor 130 provides feedback concerning the quality of the ads, such as in the form of reports or other actionable information. The ad monitor 130 may programmatically (or alternatively with human intervention) notify the advertising affiliate and/or the content provider about ads that are troubling or otherwise of an inadequate quality or inappropriate content. In this way, the advertising affiliate 120 and/or the content provider 110 may take appropriate remedial steps.

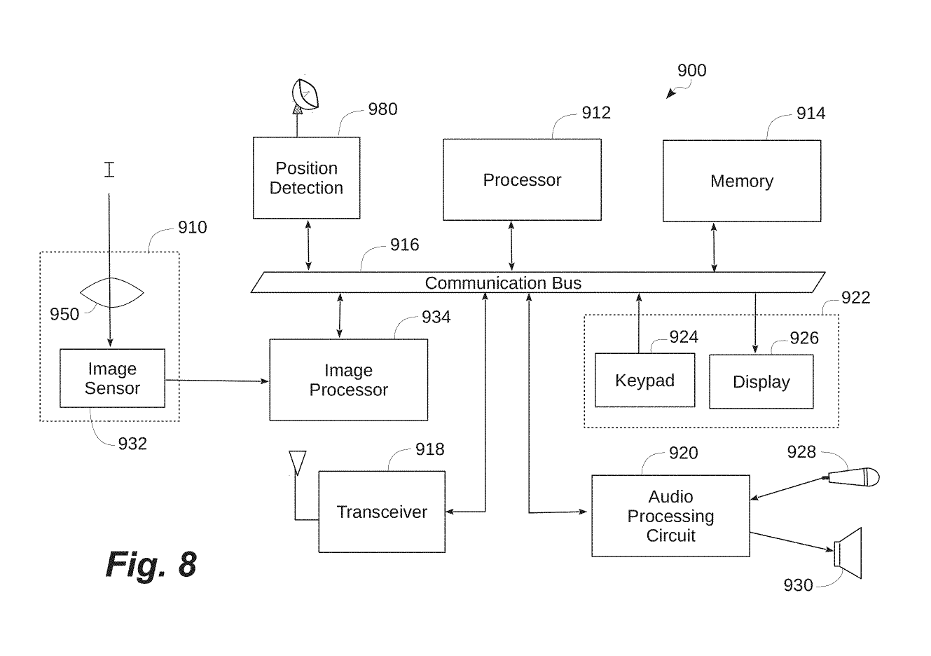

Any one or more of the several entities illustrated in FIG. 1 may communicate over the Internet 100 or other publicly accessible wide area network. Although illustrated in quasi-human form, it should be appreciated that the visitor 103 represents a computing device in use by one or more individuals. The computing device may host user-specific data or information, such as cookies, which represents a profile for the individual or individuals. Finally, the several components illustrated in FIG. 1 may be implemented using computing devices, which are generally known. One illustrative computing device that may be used to implement embodiments is illustrated in FIG. 8 and described below.

The several components illustrated in FIG. 1 implement one preferred embodiment for evaluating the nature of affiliate-served ads. Such an embodiment adds value to the content provider 110 by providing feedback on the quality and appropriateness of affiliate-served ads to the content being served by the content provider 110. What follows now is a discussion of additional detail for specific implementations of several of the components introduced in FIG. 1.

It is helpful to a complete understanding of this disclosure to begin with a general discussion of how affiliate-ads are served by a typical content provider. Turning first to FIG. 2A, a brief discussion of a simple dynamically-generated webpage is provided. To begin, a dynamically-generated webpage (i.e., page 201) includes code, such as markup language or scripts, that describe a webpage. In this simple example, page 201 includes two general types of code. First is code (e.g., HTML, JavaScript, CSS, or the like) that describes what the rendered page 250 should look like in a visitor's browser. In this example, that code is referred to as “page description” code 202. In this example, page description code 202 defines four regions of the rendered webpage 250 in which content should be displayed.

The second type of code (e.g., HTML, PHP, Perl, JavaScript, or the like) defines or identifies content to be delivered for each of the regions defined by the page description code 202. Generally stated, the content may either be defined directly or by reference. For instance, the page code 201 may itself include content, such as text within the page code 201 itself, to be displayed in a particular region of the rendered page 250. In one example, the text “Content Provider Webpage” may be included directly in page code 201 (e.g., in a paragraph tag or inline) which may be rendered in a header region 251 of the rendered page 250.

Alternatively, content may be defined by reference to another source, such as a text file, database, image file, or the like. Generally stated, a reference may be either local or external. A local reference points to content that is within the common control or domain of the web server that is hosting the page code 201. In other words, for the purpose of this discussion, “local content” refers to any content that is under common control with the web server which is hosting the page code 201. In contrast, an “external reference” refers to a target, such as content, that is in a domain different than the local domain. It is important to note that an external reference may point to a target that is in an external domain under the common control of the local domain, but it need not be. In other words, one entity may control multiple domains which each serve content for the rendered page 250, but additional content may be served from another external domain which is not under the control of that entity. By way of example, textual content 213 may be stored in a first domain (e.g., “ContentProvider.com”) and multimedia content 215 may be stored in a second domain (e.g., “ContentProviderImages.com”), both of which are controlled by the same entity (e.g., Content Provider 110). For the purpose of this discussion, both the first domain and the second domain would store “local content.”

Turning now to FIG. 2B, an example of an external reference to content that is not within the common control of the local domain is illustrated. In the illustrated example, an affiliate domain 275 hosts resources 276 which may be referenced (e.g., retrieved for use or invoked programatically) by other entities. The resources 276 may include any one or more of many different content types, such as multimedia content (e.g., ad image 277), code (e.g., script 278) that can be remotely executed, or any other type of resource. The page code 201 includes an external reference 280 that points to some resource 276 of the affiliate domain 275. Accordingly, when the page 201 is requested, each of the several tags and/or references is interpreted and its associated content is returned and displayed as rendered webpage 250 on the requester's browser.

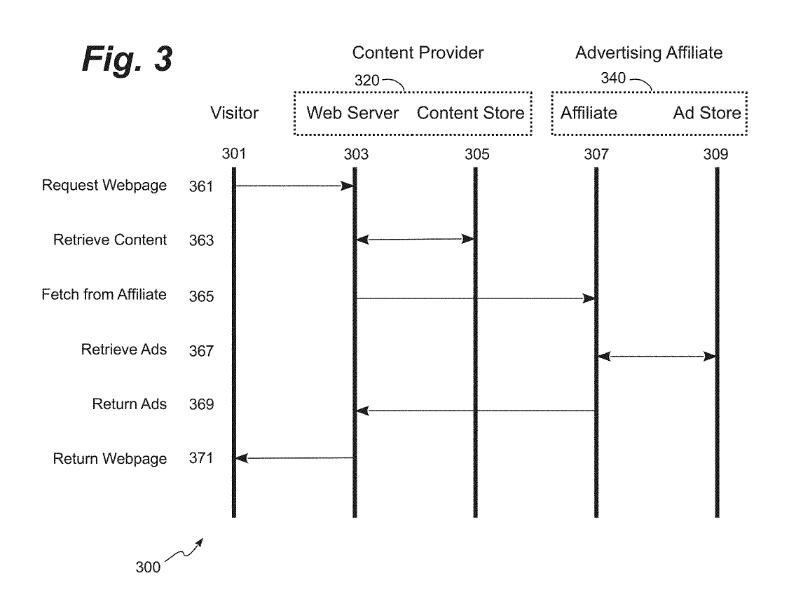

FIG. 3 is a sequence diagram 300 generally illustrating the flow of data between each of several components to accomplish the generation of a dynamic webpage as just described. The sequence begins when a visitor 301 issues a request 361 for a webpage to a web server 303 of a content provider 320. In this embodiment, the web server 303 prepares to respond to the request 361 by initiating assembly of a dynamic webpage. As noted above, the webpage may include requests for both internal content and external content. Accordingly, the web server 305 may retrieve 363 certain content for the webpage from a content store 305. In this example, the content is under the control of the content provider 320. Thus, the content provider 320 maintains its own quality control standards for that content.

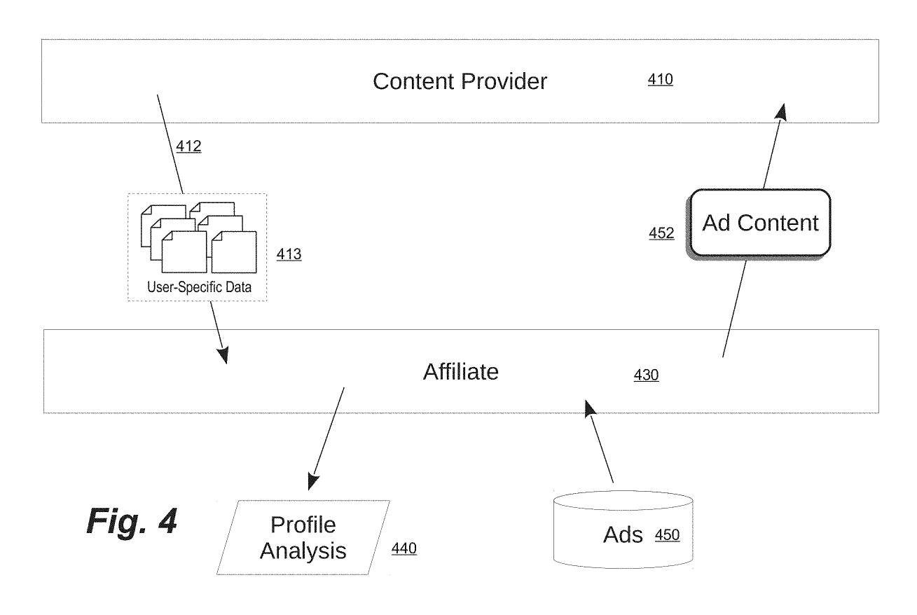

In addition, the web server 303 may also fetch 365 additional information, such as advertisements, from an advertising affiliate 340. The web server 303 may issue a request for an ad to the affiliate 307. The request 365 may include profile information (e.g., user-specific data) that helps identify the visitor 301. Specific examples of such profile information is described below in conjunction with FIG. 4. The affiliate 307 in turn retrieves 367 the ad from an ad store 309. The selection of which particular ad to retrieve 367 from the ad store 309 is based, at least partially, on the profile information. Once the ad is selected, it is returned 369 to the web server 303, which in turn incorporates it into the requested webpage and returns 371 the webpage to the visitor 301 for rendering on the visitor's browser.

To complete the discussion, FIG. 4 is a functional block diagram generally illustrating the flow of data between a content provider and an affiliate, in accordance with one embodiment. As illustrated, the content provider 410 may receive a request for a resource (e.g., a webpage) which itself (the requested resource) refers to external content (e.g., an advertisement). In the illustrated example, the requested resource is a webpage that includes a reference to content hosted by an affiliate 430. To service the original request, the content provider 410 issues an ad request 412 and transmits that request to the affiliate 430.

As is known to those skilled in the art, additional information may be transmitted along with the ad request 412. More specifically, certain user-specific data 413 may be transmitted together with the ad request 412. The user-specific data 413 is additional data that helps identify the original requesting entity. Certain specific examples of user-specific data 413 include cookies, web beacons, flash cookies, user-agent strings, referrer headers, information derived from any one or more of the foregoing, or the like. Many more examples will be immediately apparent to those skilled in the art. In short, the user-specific data 413 includes information that helps identify browsing habits of the requesting individual (or at least the requesting computing system).

The affiliate 430 takes the user-specific data 413 and the ad request 412 and executes a profile analysis 440 to identify a particular ad to return. For instance, the profile analysis 440 may reveal particular browsing habits for the requesting entity or individual which help influence which particular ad from a multiplicity of available ads 450 should be returned. For example, if the user-specific data 413 reveals that the requesting individual had recently been visiting the website of an online shoe store, the profile analysis 440 may suggest that an ad 451 related to shoes is appropriate. In that case, the affiliate 430 would then return ad content 452 to the content provider 410 including the selected ad 451 and perhaps other information, such as updated user-specific data, for example. Alternatively, the ad content 452 could include only the selected ad 451.

Turning now to FIG. 5, illustrated is one embodiment of an ad monitor 501 which may be used in various implementations of this disclosure. The preferred embodiment of the ad monitor 501 includes a management component 510, a communication component 570, an ad analyzer 520, a profile generator 540, a report generator 550, and a plurality of synthetic profiles 560. The communication component 570 may be any component that facilitates communication between disparate computing devices, such as over a local or wide area network, or the like. In one example, the communication component 570 enables communication between the ad monitor 501 and a remote content provider using at least the HTTP communication protocol. A management component 510 is configured to facilitate inter-process cooperation and proper operation. The management component 510 may also be configured with logic to schedule and marshal various events and tasks among the several components of the ad monitor 501. The management component 510 of the preferred embodiment may further include administrative control functions.

The profile generator 540 is configured to create and manage a plurality of synthetic user profiles 560, such as profile 561. In this embodiment, each profile 560 represents a fabricated browsing history of an imaginary individual. In this embodiment, the profile generator 540 is configured to simulate the browsing habits of a real person by performing a multiplicity of activities to simulate an imaginary person performing various activities, such as browsing or searching, the Internet. Each of the several profiles may represent the browsing habits of different types of real people.

To illustrate the foregoing, and referring briefly to FIG. 6, the ad monitor 501 performs a multiplicity of browsing sessions by visiting numerous other websites (e.g., websites 601-605). The profile generator 540 is configured to access each of the websites using browsing software that accumulates user-specific data from each website. For instance, the profile generator 540 may visit website 601, which may be a multimedia rich website with lots of content pertaining to entertainment, for example. By visiting website 601, the profile generator 540 accumulates whatever cookies and other user-specific data may be set by website 601. Profile generator 540 may also visit website 604, which may be a blog site having political content affiliated with a particular political party, for example. Accordingly, the profile generator 540 accumulates whatever user-specific data may be set by website 604. The profile generator 540 repeats this behavior for numerous different and varying websites having different and varying characteristics and, thereby, accumulates user-specific data corresponding to a particular browsing history or pattern. The user-specific data accumulated during such browsing session is stored in a specific profile 560.

The profile generator 540 may repeat the foregoing operations to generate different user profiles. In one embodiment, the visited websites may be selected via a variety of means, including random sampling of top websites, or targeted based on a particular demographic group. Alternatively or additionally, the visited websites may be selected to simulate the expected browsing habits of a target demographic. For example, the ad monitor 501 may be tasked with creating one user profile simulating the browsing characteristics of a mature individual and another user profile simulating the browsing characteristics of a young adult. In such a scenario, different browsing criteria may be specified to generate different profiles. For instance, a young adult may be more likely to visit a social network website 603 and a multimedia website 601, whereas a mature individual may be more interested in an industry news website 605 and a political blog 604. However, similarities are also likely. For instance, both individuals may also be interested in a shopping website 602. Accordingly, different user profiles 560 may be generated by specifying different browsing patterns which the profile generator 540 may execute.

The foregoing discussion speaks in terms of performing actual visits to websites in order to build up a profile for an imaginary user. In an alternative embodiment, visits to websites may be simulated, such as by directly retrieving ad resources specifically used for tracking users (known as “user sync” resources), with headers and metadata that simulates a visit to the website. Additional alternative techniques will also become apparent to those skilled in the art.

Returning now to FIG. 5, the content retrieval component 530 is configured to retrieve content from specified websites and pages, such as webpage 111 served by content provider 110 (FIG. 1). The content retrieval component 530 visits any one or more webpages, such as on behalf of the content provider 110, for the purpose of evaluating content (e.g., affiliate ads) rendered on the webpage 111. In one specific implementation, the content provider 110 requests one or more identified webpages or unidentified webpages within an identified website or domain. Although it is envisioned that implementations of the preferred embodiment will likely retrieve and evaluate multiple webpages from a particular website, for simplicity of this discussion, examples will be given in the context of retrieving a single webpage. It should be appreciated that, although described as a single webpage, multiple webpages may be retrieved in like manner.

The content retrieval component 530 may sample the content provider's website to increase the number of ads that are retrieved. In the preferred embodiment, sampling may occur by visiting the target website using a web browser that has native profile or measurement tools, or one that has been modified to provide such functionality. To obtain a wider range of samples, the content retrieval component 530 invokes one or more profiles 560, such as user profile 561, to simulate visiting the content provider's website by an actual user (although synthetically generated).

The requested webpage may be dynamically created and returned in the manner described above in conjunction with. FIGS. 2A and 2B. The returned webpage is then passed to an ad analyzer 520 which performs an analysis of the quality or appropriateness of at least a portion of the returned webpage. In one example, the portion analyzed is an affiliate ad served as part of the webpage. In other words, the analyzed portion may be the external ad 277 (FIG. 2B) in this example. In another example, the portion analyzed is an ad or other resource served by the content provider itself, such as multimedia content 215 (FIG. 2A).

There are many types of analyses which may be performed on the webpage portion to compute a quality score. Various combinations of the following analyses are implemented in various embodiments, with most of these analyses being implemented in the preferred embodiment. For the purpose of the following discussion, the analyzed portion is an affiliate ad, although other external content may be analyzed in a similar manner. Certain embodiments may use direct measurement of individual resources within an ad. However, alternative embodiments may measure an iframe as a proxy for directly measuring the ad.

The preferred embodiment produces measurement metrics for an ad based on one or more of the following criteria:

1. CPU Time—Producing an aggregate total (or other summary statistic) by using measurements of the ads. These measurements may be provided natively by the web browser, or determined by other code profiling mechanisms. The profiling mechanisms include one or more of the following: the wallclock time of individual function calls comprising ad load; the thread clock time of individual function calls comprising ad load; the longest non-yielding call, with respect to either wallclock or threadclock time; or the like.

2. Network Transfer Data—Using an aggregate total, other summary statistic, or distribution of the number of bytes in a network request or response, the number of resource requests made, the number of resource requests fetched from the browser cache instead of the network, the number of resource requests resulting in errors (either in aggregate, or by error code).

3. Animation Load—An animation load metric may be computing based on the total number of compositing or paint events either as a direct measurement or as a proxy for CPU time. This number can be based on one or both of the following criteria: high-frequency repaint events and CSS animation frames, occurring either in the browser's main thread or in a separate compositing or rendering thread.

4. Tracker Load—A tracker load value may be computed based on the number of “tracking pixels” or likely tracking scripts. In one implementation, this value may be produced by counting the number of resource requests determined to be likely trackers. Identification of trackers may be rule-based or statistical, and may be performed using either individual, or weighted combinations of rules. Illustrative rules that may be implemented may be based on mime types or file extensions identifying an asset as an image, missing mime types, plain text responses, small response payload sizes, response payload sizes matching exactly “known values” for tracking pixels, or the like.

5. Rich Media—A rich media score may be quantified to estimate the presence of rich media through static analysis of the ad, inspecting the file type or size of downloaded assets, inspecting measurements, or the like.

6. Secured Resource Requests—A secured resource metric may be quantified base on either the number, or proportion of, secured (SSL-enabled) requests. Non-encrypted ad resources are not eligible for HTTP2 and may actually be a detriment to performance.

7. Malware Detection—One scoring criterion may be based on an analysis of the analyzed portion for the presence of malicious code, such as “malware,” spyware,” “adware,” or the like.

The ad analyzer 520 thus creates an “ad score” which represents a quality value for the ad. Although introduced in the singular, in should be appreciated that the “ad score” may in fact be a plurality of individual scores, a cumulative score of each of one or more of the aforementioned evaluations, a weighted average of one or more such evaluations, any combination of these, or some other value or values based on one or more of the qualitative evaluations described above. The preferred embodiment produces an overall quality score based on one or more of those evaluations, using one or more methods, including but not limited to a rules-based engine, a statistical method, a predictive model, or any combination of these. For simplicity of discussion, the term “ad score” will be treated as a singular score although it should be appreciated that in practice such “ad score” may, and likely will, be composed of multiple constituent values.

Once the ad score for a particular ad has been generated, the ad analyzer 520 passes the ad score off to the report generator 550. The report generator 550 formulates a response, which may be a no-response, based on the ad score and criteria provided by the content provider. The response may take one or more of very many different forms. Certain reports will be discussed here by way of example only, and many other types of reports or reporting functions are possible.

In one embodiment, the report generator 550 formulates a report based on the “quality” of ads served in conjunction with the content provider's content. More specifically, the report generator 550 may compare the ad score for a particular ad or set of ads against a given criteria. Any ads which do not satisfy the given criteria are reported as being “bad.” For the purpose of this discussion, the term “bad” indicates that the subject ad fails the given criteria. Again, failing the given criteria may be the result of a single metric falling below said criteria, a plurality of metrics falling below multiple criteria, or one or more metrics falling below an average, weighted average, or the like. Identifying an ad as “bad” may be accomplished in many ways, as will be understood by those skilled in the art.

For any one or more ads identified as bad, the report generator 550 may issue a notification of such either to the content provider 110, the advertising affiliate 120, to some third-party, or to any combination of these. The notification may take the form of an automated request to prevent any bad ads from being served in conjunction with the content provider's website. In one specific implementation, such a request may take the form of an automated e-mail, a reporting webpage, an API call to the advertising affiliate 120, or the like.

FIG. 7 is a logical flow diagram 700 generally illustrating operations performed by one specific implementation of a preferred embodiment. The several operations shown in FIG. 7 may be implemented using computing devices, such as the illustrative computing device shown in FIG. 8 and described below. It should be appreciated that the several operations shown in FIG. 8 implement the preferred embodiment, and many other operations may additionally be added. Likewise, some of the operations may be combined or even eliminated without departing from the spirit and scope of the disclosure.

To begin, a user profile is generated (701) by visiting a predefined set of websites. The user profile includes at least website cookies that represent the websites visited. The target website is then visited (703) using an instrumented browser. The instrumented browser includes the user profile generated at step 701. The instrumented browser collects metrics related to ad performance and quality.

If a sufficient number of samples of the target website have not yet been collected, the process repeats until a sufficient number of samples have been collected (705). With sufficient samples, ads are uniquely identified from the sampled websites (707). The ads are uniquely identified so that individual ads may be evaluated and scored in an actionable manner. In one embodiment, uniquely identifying an ad may be accomplished based on the URL or payload of the retrieved resources. In one specific implementation, the following techniques may be implemented to generate a unique identifier for an ad:

1. Performing machine learning on the URIs or payload of the associated resources. Example inputs may include the HTML of an ad, or extracted features including the image source URL, iframe source URL, link anchor URLs, or SWF object references, for example.

2. For each URL, this may include tokenizing or otherwise deconstructing the URL to create features suitable for machine learning.

3. Identification techniques may include clustering approaches, neural networks, generating regular expressions to extract key metadata.

Once ads are uniquely identified, ad metrics for each unique ad are aggregated (709). If one or more ads reflect ad metrics which that worse than some pre-defined threshold, those ads are identified (711). Any ads which do not fail the pre-defined threshold are marked “good” (713) and those that do fail the pre-defined threshold are added to a list of reportable ads, together with sufficient information to uniquely identify the ad (715). Once all the ads have been evaluated (717), any low-quality ads are reported to the entity requesting such notification (719). Such notification may take the form of an email, API call, human-generated report, or the like.

The process may await confirmation that the low-quality ads have been resolved or otherwise handled (721). The process may iterate a number of times or continuously for so long as is deemed necessary. For instance, a content provider may subscribe for an ad monitoring service, or the like. Alternatively, the process illustrated in FIG. 7 may be executed only once. Many other alternatives are equally possible regarding the repeated execution of the process 700. In addition, it should be appreciated that the process illustrated in. FIG. 7 is but one preferred embodiment, and many other implementations of this disclosure will become apparent to those skilled in the art.

FIG. 8 is a functional block diagram generally illustrating one possible example of a computing device 900 that may be used to implement various embodiments. As shown, computing device 900 includes several functional components to enable policing online advertisements. The example computing device may be implemented as one or more of any number of devices, such as a mobile phone, a tablet computer, a personal digital assistant, a notebook or ultrabook computer, a desktop computer, a server computer, a virtual machine, or the like.

The computing device 900 may include a processor 912, a memory 914, communication circuit 916, transceiver 918, audio processing circuit 920, user interface 922, image sensor 932, image processor 934, and optical system 950. Processor 912 controls the operation of the computing device 900 according to programs stored in program memory 914. The communication circuit 916 interfaces the processor 912 with the various other components, such as the user interface 922, transceiver 918, audio processing circuit 920, and image processing circuit 934. User interface 922 may include a keypad 924 and a display 926. Keypad 924 allows the operator to key in alphanumeric characters, enter commands, and select options. The display 926 allows the operator to view output data, such as entered information, output of the computing device 900, images or other media, and other service information. In certain computing devices, the user interface 922 combines the keypad 924 and the display 926 into a touchpad display.

The computing device 900 may also include a microphone 928 and speaker 930 though certain computing devices may not have such features. Microphone 928 converts sounds into electrical audio signals, and speaker 930 converts audio signals into audible sound. Audio processing circuit 920 provides basic analog output signals to the speaker 930 and accepts analog audio inputs from the microphone 928. Transceiver 918 is coupled to an antenna 936 for receiving and transmitting signals on a suitable communications network (not shown).

Image sensor 932 captures images formed by light impacting on the surface of the image sensor 932. The image sensor 932 may be any conventional image sensor 932, such as a charge-coupled device (CCD) or complementary metal oxide semiconductor (CMOS) image sensor. Additionally, the image sensor 932 may be embodied in the form of a modular camera assembly with or without an integrated optical system 950. Image processor 934 processes raw image data collected by the image sensor 932 for subsequent output to the display 926, storage in memory 914, or for transmission by the transceiver 918. The image processor 934 is a signal microprocessor programmed to process image data, which is well known in the art. A position sensor 980 detects the position of the computing device 900 and generates a position signal that is input to the microprocessor 912. The position sensor 980 may be a Global Positioning System sensor, potentiometer, or other measuring device known in the art of electronics.

Other embodiments may include combinations and sub-combinations of features described or shown in the several figures, including for example, embodiments that, are equivalent to providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

In the foregoing description, numerous details have been set forth in order to provide a sufficient understanding of the described embodiments. In other instances, well-known features have been omitted or simplified to not unnecessarily obscure the description.

A person skilled in the art in view of this description will be able to practice the disclosed invention. The specific embodiments disclosed and illustrated herein are not to be considered in a limiting sense. Indeed, it should be readily apparent to those skilled in the art that what is described herein may be modified in numerous ways. Such ways can include equivalents to what is described herein. In addition, the invention may be practiced in combination with other systems. The following claims define certain combinations and subcombinations of elements, features, steps, and/or functions, which are regarded as novel and non-obvious. Additional claims for other combinations and subcombinations may be presented in this or a related document.

The invention is:

1. A system for monitoring and policing online advertisements, comprising:
a profile generator configured to cause browsing software executing on a monitoring computing system to construct a synthetic user profile by retrieving resources from a plurality of third-party websites, the resources including user-specific content operative to substantially uniquely identify the synthetic user profile, the user-specific content being reflective of browsing habits;
a content retrieval component configured to instantiate the synthetic user profile, and to retrieve a target webpage from a target website based on the synthetic user profile, the target website comprising internal content and at least one instance of promotional content; and
an analyzer configured to evaluate the promotional content to compute an ad score for the promotional content, the ad score providing a quantitative value representing at least one quality metric for the promotional content.

2. The system recited in claim 1, further comprising
a report generator configured to issue a report based on the ad score, the report including an indication that the promotional content fails a predetermined threshold of quality for content made available from the target website.

3. The system recited in claim 2, wherein the report comprises a notification to an affiliate website that the promotional content has failed the threshold of quality.

4. The system recited in claim 3, wherein the report further comprises a notification to cease making the promotional content available in conjunction with the target website.

5. The system recited in claim 1, wherein the promotional content comprises an online advertisement, and the promotional content is made available from an affiliate web server.

6. The system recited in claim 1, wherein the promotional content comprises internal content made available from the target website.

7. The system recited in claim 1, wherein the internal content is hosted by a target web server and the external content is hosted by an affiliated web server, and further wherein the target webpage is dynamically generated by combining the internal content with the external content prior to being transmitted to the content retrieval component.

8. The system recited in claim 2, wherein the report comprises an email uniquely identifying the external resource and an indication that the external resource failed the predetermined threshold of quality.

9. The system recited in claim 2, wherein the report comprises a call to an Application Programming Interface exposed by an affiliate web server, the report further comprising an indication that the external resource failed the predetermined threshold of quality.
